(19) United States
(12) Patent Application Publication
(10) Pub. No.: US 2026/0336633 A1
(43) Pub. Date: Oct. 29, 2026

(54) METHOD AND SYSTEM FOR CHECKING A TRAJECTORY FOR FREEDOM FROM COLLISION

(71) Applicant: AUMOVIO Autonomous Mobility Germany GmbH, Ingolstadt (DE)

(72) Inventors: Ralph Grewe, Modautal (DE); Maxim Arbitmann, Frankfurt am Main (DE)

(73) Assignee: AUMOVIO Autonomous Mobility Germany GmbH, Ingolstadt (DE)

(21) Appl. No.: 19/387,069

(22) Filed: Nov. 12, 2025

(30) Foreign Application Priority Data
Nov. 13, 2024 (DE) 102024210920.7

(51) Int. Cl. B60W 50/00; B60W 40/02

(52) U.S. Cl. CPC B60W 50/0097; B60W 40/02; B60W 2554/20; B60W 2554/4041

(57) ABSTRACT

A method for checking a planned vehicle trajectory for freedom from collision, based on an environmental model having a plurality of cells each corresponding to a region surrounding the vehicle. The cells being assigned information indicating whether the region represented by the cell can be traversed without collision. The first model is provided by a first processor having a first safety level lower than a safety level necessary to check the trajectory for freedom from collision and determines at least one trajectory for checking regarding freedom from collision based on the first model. A second information-reduced model is generated from the first model or a further model different from the first model by reducing the first model or the further model to information relevant to collision checking of the trajectory. A second processor having a second safety level performs a collision check on the trajectory based on the second model.

### CROSS REFERENCE TO RELATED APPLICATION

This application claims priority to German Application No. 10 2024 210 920.7, filed Nov. 13, 2024, the contents of such application being incorporated by reference herein.

### FIELD OF THE INVENTION

The invention relates to a method and system for checking a planned trajectory of a vehicle for freedom from collision.

### BACKGROUND OF THE INVENTION

Driver assistance systems which have a trajectory planner providing a collision-free trajectory on the basis of which the at least partially autonomous control of the vehicle is performed are already known. In this case, the trajectory planner determines for example a plurality of test trajectories, also referred to as trajectory hypotheses, then checks these test trajectories for being free of collisions and, after a positive collision-free check, a collision-free trajectory is selected on the basis of which an at least semi-autonomous driving process is carried out.

For collision checking, it is possible to use a grid-based environmental model having a multiplicity of cells and cell attributes associated with these cells. Based on these cell attributes, it is possible to check whether a planned trajectory is traversable without collision or not. For example, the cell attributes can indicate whether a cell is free and thus traversable without collision or is occupied by a third object.

It is problematic that the processor used to collision check a trajectory using a grid-based environmental model has high memory and computing resources, but at the same time has also to comply with a high safety integrity level (so-called ASIL-level; ASIL: Automotive Safety Integrity Level). In particular, it must comply with safety integrity level ASIL D, for L4 systems and higher, in accordance with SAE J3016. However, there are no or only very expensive processors available that meet this safety integrity level and at the same time provide the required memory and computing capacities.

### SUMMARY OF THE INVENTION

Based on this, an aspect of the invention is a method for checking a planned trajectory of a vehicle for freedom from collision, which method offers a high level of safety and can be carried out with processors available on the market that meet the required safety integrity level.

This aspect is achieved by a method having the features of independent claim 1. Preferred embodiments form the subject matter of the dependent claims. A system for checking a planned trajectory of a vehicle for freedom from collision is the subject matter of an additional independent claim.

According to a first aspect, a method for checking a planned trajectory of a vehicle for freedom from collision is disclosed, in which method a first environmental model is used. The first environmental model has a plurality of cells which each correspond to an environmental region surrounding the vehicle. In other words, each cell thus contains information relating to a discrete environmental region. The cells are each associated with information which indicates whether the environmental region represented by the cell is traversable without collision. The first environmental model is processed by a first processor having a first safety integrity level which is lower than a safety level necessary to check the trajectory for freedom from collision. The first environmental model is preferably also generated by the first processor. In particular, the first processor does not meet the ASIL D level which is required for L4 systems according to SAE J3016 or higher, incorporated herein by reference. At least one trajectory, which is to be checked with regard to freedom from collision, is determined by the first processor on the basis of the first environmental model. A second, information-reduced environmental model is generated from the first environmental model or a further environmental model which is different from the first environmental model by reducing the first environmental model or the further environmental model to information relevant for the collision check of the trajectory. The further environmental model can be provided by a further processor having a safety integrity level that is lower than a safety level required to check the trajectory for freedom from collision. In particular, the further processor does not meet the ASIL D level which is required for L4 systems according to SAE J3016 or higher. A second processor with a second safety integrity level that corresponds at least to the safety integrity level required for checking the trajectory for freedom from collision performs a collision check on the at least one trajectory on the basis of the second, information-reduced environmental model.

The technical advantage of the method is that, by dividing the tasks over at least two processors and reducing the information from the first environmental model to a second environmental model, it is made possible to use a grid-based environmental model to plan test trajectories and to subsequently check these test trajectories for freedom from collision with a commercially available processor having the required safety integrity level. The advantage of using a first environmental model for determining the at least one trajectory, and a further environmental model which differs from the first environmental model and from which the second information-reduced environmental model is generated, is that higher safety requirements can be met through the use of two differently implemented environmental models, for example the ISO 21448 standard “Safety of the intended Functionality” or ISO/PAS 8800, each of which are incorporated herein by reference.

According to one exemplary embodiment, the cells of the first environmental model and/or of the further environmental model are each assigned multiple probability values. A first probability value indicates the probability that the respective cell is free. Thus, the information relating to the occupancy of a cell is not purely binary information, but rather a probability value with a higher bandwidth of possible values, which is advantageous for the information reduction for the second environmental model.

According to one exemplary embodiment, a second probability value indicates the probability that the respective cell is occupied by a static object. Thus, the information relating to the occupancy of a cell is not purely binary information, but rather a probability value with a higher bandwidth of possible values, which is in turn advantageous for the information reduction for the second environmental model.

According to one exemplary embodiment, a third probability value indicates the probability that the respective cell is occupied by a dynamic object. Thus, this information is also not purely binary information, but rather a probability value with a higher bandwidth of possible values, which is in turn advantageous for the information reduction for the second environmental model.

According to one exemplary embodiment, a plurality of probability mean values are determined on the basis of the probability values of the cells of the first environmental model and/or of the further environmental model. The probability mean values are formed in each case by averaging the probability values of a group of cells which are occupied at least temporarily when the body of the vehicle is traversing the trajectory. The averaging in this case can be an equal-weighted averaging or an averaging with an unequal weighting. The probability mean values are used as information of the second, information-reduced environmental model by the second processor for checking the trajectory for freedom from collision. This has the advantage that the information reduction that is carried out in the formation of the second environmental model uses a large amount of information that is slightly unsharp and has mutual information redundancy, so that falsification of individual values or a few values does not lead to an incorrect decision as to the existence of freedom from collision if interpreted otherwise correctly.

In accordance with one exemplary embodiment, at least one first probability mean value is determined that indicates the probability that a group of cells occupied at least temporarily by the body of the vehicle when traversing the trajectory is free. This probability mean value thus combines the first probability values of the group of cells into a single value, which is a measure of the probability with which the group of cells is free and can thus be traversed without collision by the vehicle.

In accordance with one exemplary embodiment, at least one second probability mean value is determined that indicates the probability that at least one static object is present in a group of cells occupied at least temporarily by the body of the vehicle when traversing the trajectory. This probability mean value thus combines the second probability values of the group of cells into a single value, which is a measure of the probability with which the group of cells is occupied statically and thus cannot be traversed without collision by the vehicle. It is evident that the first and second probability mean values have information redundancy, since an occupied group of cells is not free, or vice versa. This information redundancy can be used by the second processor for plausibility checking.

In accordance with one exemplary embodiment, at least one third probability mean value is determined that indicates the probability that at least one dynamic object is present in a group of cells occupied at least temporarily by the body of the vehicle when traversing the trajectory. This probability mean value thus combines the third probability values of the group of cells into a single value, which is a measure of the probability with which the group of cells is occupied by a dynamic object (i.e. the object has proper motion) and thus cannot be traversed without collision by the vehicle. It is evident that the first and third probability mean values have information redundancy, since a group of cells occupied by a dynamic object is not free, or vice versa. This information redundancy can be used by the second processor for plausibility checking.

According to one exemplary embodiment, the probability mean values are formed by averaging the probability values of the cells of the first environmental model and/or of the further environmental model that are temporarily occupied by the body of the vehicle when traversing the entire trajectory to be checked. In other words, averaging is performed over the entire trajectory length. This achieves a high information reduction between the first and the second environmental model.

According to one exemplary embodiment, the probability mean values relate to a group of cells of the first environmental model and/or of the further environmental model which are occupied by the body of the vehicle at a certain point in time when traversing the trajectory. In other words, the group of cells extends only over a partial length of the trajectory to be checked for freedom from collision. The second environmental model therefore comprises a plurality of probability mean values for several groups of cells which are provided in a distributed manner along the trajectory to be checked. The groups may overlap. Alternatively, the groups can be provided so as to adjoin one another without overlapping. This allows the second processor to gradually check the trajectory for freedom from collision.

According to one exemplary embodiment, a plurality of groups of probability mean values are used to check the trajectory for freedom from collision, wherein each group of probability mean values respectively relates to a group of cells of the first environmental model and/or of the further environmental model which are occupied at different times while the body of the vehicle is traversing the trajectory. Therefore, the freedom from collision for the trajectory can be checked gradually and the plurality of probability mean values associated with a group of cells bring about information redundancy that increases the safety of the collision checking on the trajectory.

According to one exemplary embodiment, a group of probability mean values has:
a respective first probability mean value which indicates the probability that a group of cells of the first environmental model and/or of the further environmental model which is occupied by the body of the vehicle at a certain point in time when traversing the trajectory is free;
a respective second probability mean value, which indicates the probability that a group of cells of the first environmental model and/or of the further environmental model which are occupied by the body of the vehicle at a certain point in time when traversing the trajectory, is occupied by at least one static object;
a respective third probability mean value, which indicates the probability that a group of cells of the first environmental model and/or of the further environmental model which are occupied by the body of the vehicle at a certain point in time when traversing the trajectory, is occupied by at least one dynamic object.

This triple of values results in a high level of information redundancy, which further increases the security of the collision checking of the trajectories.

According to one exemplary embodiment, during the assessment of the trajectory for freedom from collision, the probability mean values of a group of probability mean values are compared with one another and a plausibility check is performed on the basis of the comparison of the probability mean values of a group. By comparing the probability mean values it is possible to detect whether they are in a ratio with respect to one another which indicates a high certainty of freedom from collision of the trajectory, or whether there are discrepancies between the probability mean values which indicate an uncertain freedom from collision.

According to one exemplary embodiment, the second, information-reduced environmental model is formed by reducing the first environmental model and/or of the further environmental model to those cells which are temporarily occupied by the body of the vehicle when traversing the trajectory. In other words, the first environmental model and/or the further environmental model are/is locally restricted to the environment of the vehicle which is relevant for the collision check. As a result, it is possible to obtain a second environmental model that can be processed by the second processor but still has a sufficient number of cell attributes, which are associated with the respective cells, to have information redundancy during collision check.

According to a further aspect, a system for checking a trajectory of a vehicle for freedom from collision is disclosed. The system has a first processor which processes and if appropriate also provides a first environmental model of the vehicle, which comprises a plurality of cells. The cells each correspond to an environmental region surrounding the vehicle. The cells are each assigned information which indicates whether the environmental region represented by the cell is traversable without collision. The first processor has a first safety integrity level that is lower than a safety level necessary to check the trajectory for freedom from collision. The first processor is configured to determine at least one trajectory that needs to be checked with respect to freedom from collision on the basis of the first environmental model. The first processor or a further processor, which has a safety integrity level that is lower than a safety level necessary to check the trajectory for freedom from collision, is configured to generate a second, information-reduced environmental model from the first environmental model or a further environmental model by reducing the first environmental model or the further environmental model to information relevant to the collision checking of the trajectory. In addition, a second processor is provided which has a second safety integrity level which corresponds at least to the safety integrity level required to check the trajectory for freedom from collision. The second processor is configured to perform a collision check on the trajectory on the basis of the second, information-reduced environmental model.

A “second environmental model” within the meaning of an aspect of the present invention can likewise be a cell-based environmental model or else an environmental model in which the cell information from a plurality of cells from the first environmental model or from the further environmental model has been combined to form combination information.

A “further environmental model” within the meaning of an aspect of the present invention is likewise a cell-based environmental model which is similar to the first environmental model but differs from the first environmental model since it was generated by a different method.

In the context of an aspect of the invention, the expressions “approximately”, “substantially” or “about” mean deviations from the respectively exact value of +/−10%, preferably by +/−5%, and/or deviations in the form of changes that are insignificant for the function.

Developments, advantages and possible uses of aspects of the invention will be apparent from the following description of exemplary embodiments and from the figures. Here, all of the features described and/or illustrated in the figures are, in principle, the subject matter of an aspect of the invention, individually or in any desired combination, irrespective of their combination in the claims, or their back-relationship. The content of the claims is also made an integral part of the description.

### BRIEF DESCRIPTION OF THE DRAWINGS

Aspects of the invention will be explained in greater detail below based on the figures in the context of exemplary embodiments. In particular:

FIG. 1 shows, by way of example, a schematic illustration of a vehicle with a sensor system for detecting the environment;

FIG. 2 shows, by way of example, a schematic illustration of a system for collision checking of a trajectory, which system has a first and a second processor;

FIG. 3 shows, by way of example, a schematic illustration of a further system for collision checking of a trajectory, which system has a first processor for providing at least one trajectory, a further processor for generating the second, information-reduced environmental model and a second processor for collision checking the at least one trajectory on the basis of the second, information-reduced environmental model;

FIG. 4 shows, by way of example, a first environmental model which shows the environment of the vehicle in the region of the trajectory to be checked;

FIG. 5 shows, by way of example, a block diagram that illustrates the steps of the method for checking a trajectory for freedom from collision;

FIG. 6 shows, by way of example, a section of the first environmental model or of the further environmental model and the illustration of a group of cells which is used to form the second environmental model;

FIG. 7 shows, by way of example, a section of the first environmental model or of the further environmental model and the illustration of a plurality of groups of cells which are used to form the second environmental model;

FIG. 8 shows by way of example a bar graph which illustrates the first to third probability mean values of the groups of cells according to FIG. 6 at the times t1 to t5.

### DETAILED DESCRIPTION OF EXEMPLARY EMBODIMENTS

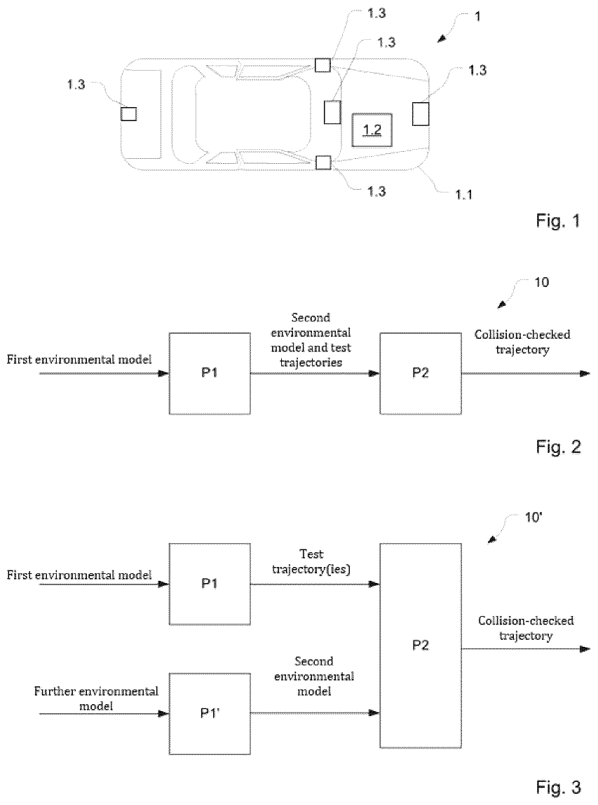

FIG. 1 shows by way of example and schematically a vehicle 1 having a body 1.1. The vehicle 1 has a driver assistance system, by means of which the vehicle 1 can be moved at least partially autonomously according to level 2 of the J3016 standard of the standardization organization SAE International, in particular also highly autonomously according to level 3 of the J3016 standard of the standardization organization SAE International, particularly preferably also fully autonomously according to level 4 of the J3016 standard of the standardization organization SAE International. The driver assistance system comprises, inter alia, a trajectory planner and a unit for checking the trajectory for freedom from collision.

The vehicle 1 comprises a plurality of sensors 1.3, by means of which the environment of the vehicle 1 can be detected. The sensors may comprise different types of sensor and may be selected from the group of following sensor types: radar sensor, camera, ultrasonic sensor, LIDAR sensor, etc.

The vehicle 1 comprises a computing unit 1.2 that is designed to process information from the sensors 1.3 of the vehicle 1 or else information derived from this sensor information and, on the basis thereof, to create a first environmental model 2 of the environmental region of the vehicle 1 in which the vehicle 1 is currently located.

The first environmental model 2 is a grid-based environmental model having a plurality of cells Z. Each cell Z of the first environmental model 2 relates to a discrete environmental region. This cell Z is assigned cell attributes that characterize this discrete environmental region. The cell attributes can indicate, for example, whether the cell Z is free and thus traversable or whether the cell Z is occupied and hence non-traversable. In the case of the cell attribute “occupied”, it may additionally be specified whether the cell is occupied by a dynamic or a stationary object. It goes without saying that the cells Z may be assigned a plurality of further types of cell attributes, for example the height of the object, the direction of movement of the object, etc., in order to obtain a detailed environmental model.

Trajectory planning is carried out on the basis of this first environmental model 2. In particular, by means of the first environmental model 2, the computing unit 1.2 determines a plurality of test trajectories, then these are checked for freedom from collision, and one of these test trajectories is selected after the collision check. The vehicle 1 is then controlled on the basis of the selected trajectory T.

FIG. 2 shows a block diagram of a system 10 that is used to plan a collision-free trajectory T on the basis of the first environmental model 2.

The system 10 comprises a first processor P1 and a second processor P2. The first processor P1 has a higher computing power than the second processor P2. However, the first processor P1 only complies with a first safety integrity level (known as the ASIL level), which is lower than the second safety integrity level that is met by the second processor P2. In particular, the first safety integrity level of the first processor P1 is not sufficient to meet the required safety requirements for calculating a collision-free trajectory. The second safety integrity level of the second processor P2, on the other hand, meets the required safety requirements for calculating a collision-free trajectory, but the memory and computing resources of the second processor P2 are not sufficient to carry out the calculations required for the creation of a collision-free trajectory directly on the basis of the first environmental model 2.

FIG. 3 shows a block diagram of a further system 10′, which can be used for planning a collision-free trajectory T.

The system 10′ in turn comprises a first processor P1 and a second processor P2 having the same tasks and the same properties in respect of computing power and safety integrity level as was described above with regard to system 10 of FIG. 2. Deviating therefrom, system 10′ comprises a further processor P1′. This further processor P1′ in turn has a higher computing power than the second processor P2 but a lower safety integrity level than the second processor P2. For example, the further processor P1′ can have the same safety integrity level as the first processor P1. The difference between the system 10′ of FIG. 3 and the system 10 shown in FIG. 2 is that the calculation of the at least one test trajectory and the generation of the second, information-reduced environmental model are carried out on different processors P1, P1′ and not by a single processor, namely the first processor P1.

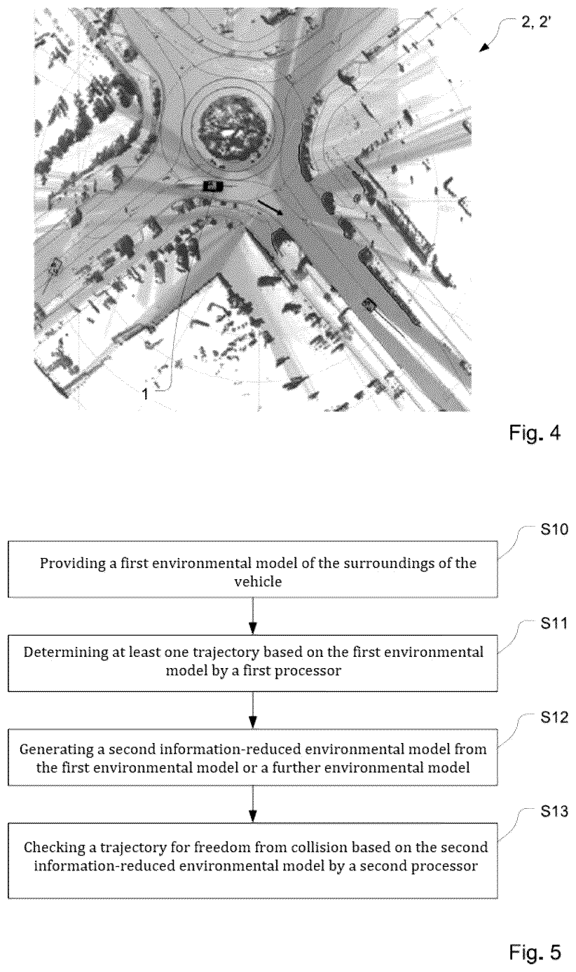

FIG. 4 shows, by way of example, a first environmental model 2. As described above, the first environmental model 2 is a grid-based environmental model, in which, however, the individual cells Z are not discernible in FIG. 4 due to the small cell size. The cell attributes of the cells Z are illustrated in FIG. 4 by different gray shades, wherein the lighter gray color shows cells Z that are traversable and the darker gray color shows the cells Z which are occupied by objects and are thus not traversable without collision.

FIG. 5 shows a block diagram illustrating the method steps of a method for checking a planned trajectory to be traveled on by a vehicle for freedom from collision. The method comprises the following steps:

First of all, a first environmental model 2 is provided which has a plurality of cells Z, wherein the cells Z each correspond to an environmental region surrounding the vehicle 1 and the cells Z are each assigned information (also referred to as cell attributes) which indicate whether the environmental region represented by the cell Z can be traversed without collisions (S10). This first environmental model 2 is processed by the first processor P1.

Subsequently, at least one trajectory T is determined by the first processor P1, which trajectory has to be checked with regard to freedom from collision (S11).

In particular, the first processor P1 calculates one or more trajectories T, also called test trajectories, on the basis of the first environmental model 2, which trajectories are to be checked for collision. It should be noted that the first processor P1 may also be configured to perform both tasks, namely to create the first environmental model 2 and to determine one or more test trajectories on the basis of this first environmental model 2.

Subsequently a second, information-reduced environmental model 3 is generated from the first environmental model 2 or a further environmental model which is different from the first environmental model by reducing the first environmental model 2 or the further environmental model 2′ to information, which is relevant for the collision check of the respective trajectory T (S12).

The second processor P2, which has a second safety integrity level that corresponds at least to the safety integrity level required for checking the trajectory T for freedom from collision, then performs a collision check on the at least one trajectory on the basis of the second, information-reduced environmental model 3 (S13).

The information reduction is performed in such a way that the second, information-reduced environmental model 3 has a reduced feature space which has the information required for the collision check of the trajectory T and can be processed by the second processor P2 with its limited computation resources. However, the information reduction preferably takes place in such a way that the second, information-reduced environmental model 3 nevertheless has information redundancies for each cell Z, so that a falsification of information resulting from noise or other interfering effects is corrected and does not lead to an incorrect decision (i.e. an incorrect assessment of the trajectory as not collision-free although actually traversable, or vice versa).

The information reduction can be effected in various ways, as will be described in more detail below.

Initially, the information reduction can be achieved by restricting the second environmental model 3 to those cells Z which are traversed by the body 1.1 of the vehicle 1 when traveling along the trajectory T to be checked for collision. In other words, the first environmental model 2 or the further environmental model 2′ is tailored to the region around the trajectory T which is actually traversed by the vehicle 1. Thus, when the second environmental model 3 is generated, only the first environmental model 2 or the further environmental model 2′ is spatially restricted to the region relevant for traversing the trajectory.

According to a preferred exemplary embodiment, the information reduction of the first environmental model 2 or of the further environmental model 2′ is carried out by combining, in particular averaging (with equal or unequal weighting) a plurality of probability values W1-W3 which are assigned to the respective cells Z of the first environmental model 2 or of the further environmental model 2′.

For this purpose, the cells Z of the first environmental model 2 or of the further environmental model 2′ are each preferably assigned multiple probability values W1-W3, wherein a first probability value W1 indicates the probability that the respective cell Z is free and thus traversable by the vehicle 1. A second probability value W2 indicates the probability of the respective cell Z being occupied by a static object and therefore not being traversable by the vehicle 1. A third probability value W3 indicates the probability that the respective cell Z is occupied by a dynamic object and therefore not traversable at the time represented by the first environmental model 2. The association of a plurality of probability values W1-W3 with the respective cells of the first environmental model 2 or of the further environmental model 2′ has the technical advantage that information redundancy is thereby created. In the case of a cell which is assigned, for example, a high probability value W1 for the cell attribute “free”, but at the same time also has a high probability value W2 for the cell attribute “occupied by static object”, it is possible to identify it as a faulty cell Z of the first environmental model 2 or of the further environmental model 2′. This information redundancy can be used to ensure that, despite falsification of individual or few values, no incorrect decision is made with regard to the freedom from collision of trajectory T by taking into consideration larger regions of the first environmental model 2 or of the further environmental model 2′.

In a first embodiment variant, it is possible to generate a second environmental model 3 from the first environmental model 2 or the further environmental model 2′, the cells Z of which merely have a plurality of probability values W1-W3 which indicate the probability of the cells being occupied (for example a probability value tuple with probability values for “occupied” and “free” or a probability value triple with probability values for “occupied with static object”, “occupied with dynamic object” and “free”). In other words, the information reduction for providing the second environmental model 3 from the first environmental model 2 or the further environmental model 2′ is carried out by reducing the cell attributes exclusively to the aforementioned probability values W1-W3.

In a second embodiment variant, when the second environmental model 3 is generated, probability values W1-W3 assigned to the respective cells Z in the first environmental model 2 or in the further environmental model 2′ are fused to form probability mean values WM1-WM3. In this case, a group G of multiple cells is selected from the first environmental model 2 or the further environmental model 2′, the probability values assigned to this group G of cells are combined to form a probability mean value, and this probability mean value is used as a value for the group G of cells in the second environmental model 3. In particular, a plurality of probability mean values WM1-WM3 are calculated for the group G of cells, specifically for example a first probability mean value WM1 from the first probability values W1, which indicate whether the respective cells Z of the group G of cells are free, and a second probability mean value WM2 from the second probability values W2, which indicate whether the respective cells T of the group G of cells are occupied by at least one static object and a third probability mean value WM3 from the third probability values W3, which indicate whether the respective cells Z of the group G of cells are free.

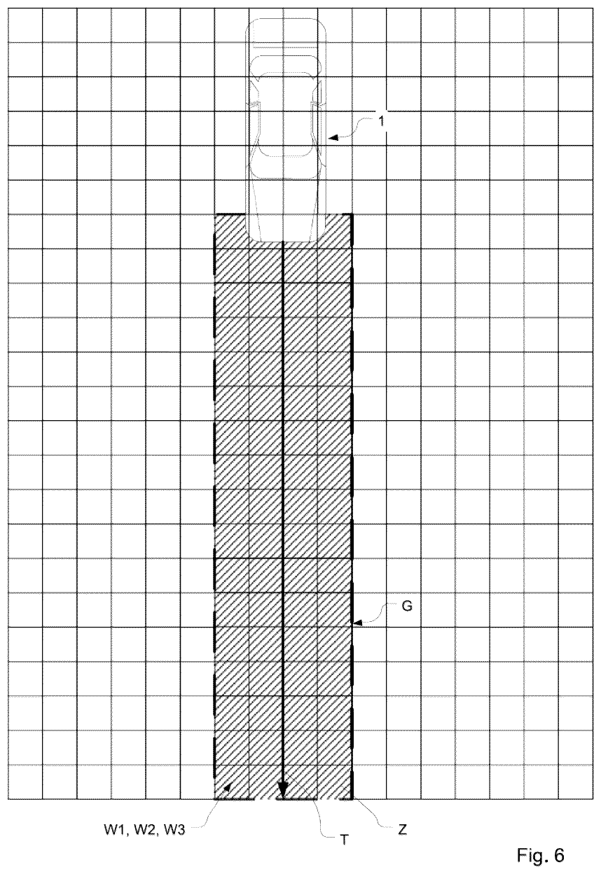

FIG. 6 illustrates a trajectory T planned by a trajectory planner of a vehicle 1. The grid shown defines the cells Z of the first environmental model 2 or of the further environmental model 2′. The cells Z are each assigned probability values W1, W2, W3, wherein W1 defines the first probability value, W2 defines the second probability value and W3 defines the third probability value. In the exemplary embodiment shown, the group G of cells is indicated by the border shown using dashed lines. The group G of cells comprises the cells Z along the trajectory T that are traversed by the body 1.1 of the vehicle 1 when traveling on the trajectory T. In other words, the group G of cells comprises those cells Z that are located in the travel channel of the vehicle 1 and therefore must be free in order to prevent the vehicle 1 from colliding with surrounding objects. It goes without saying that, in order to increase driving safety and the acceptance of the driver assistance system by the occupants of the vehicle 1, it is possible to take into account a safe distance from surrounding objects, i.e. the travel channel is chosen to be larger than the region actually traversed by the vehicle body, by taking a safety buffer into account.

The group G of cells can extend along the entire trajectory T to be checked or else can relate only to a partial length of the trajectory T to be checked.

From the multiple probability values W1, W2, W3, multiple probability mean values WM1, WM2, WM3 are then calculated for the group G of cells. The probability mean values WM1, WM2, WM3 are obtained in each case by averaging the probability values W1, W2, W3 for the group G of cells, i.e. the first probability values W1 of the group G of cells are used to generate the first probability mean value WM1, the second probability values W2 of the group G of cells are used to generate the second probability mean value WM2 and the third probability values W3 of the group G of cells are used to generate the third probability mean value WM3. The averaging in this case may be an equal-weighted averaging or a weighted averaging with different weighting factors at least for parts of the group G of cells. In particular, cells Z that are closer to the vehicle 1 can be given a higher weighting than cells Z that are further away from the vehicle 1.

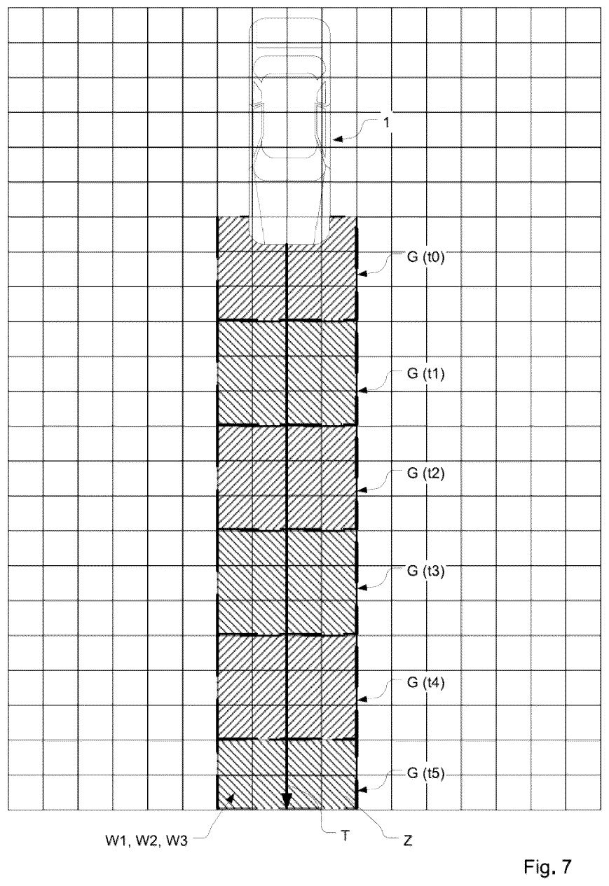

FIG. 7 shows an alternative embodiment of the grouping of cells along the trajectory, specifically a grouping into a plurality of groups G of cells which are relevant for freedom from collision of the trajectory T in successive time steps. For example, the trajectory T can be divided into multiple time steps t0-t5 and the cells Z can be grouped on the basis of the time steps. In this case, in contrast to what is shown in FIG. 7, the groups of cells may also partially overlap as seen in the longitudinal direction of the trajectory T. Therefore, multiple first, second and/or third probability mean values WM1, WM2, WM3 are calculated for each trajectory T, in particular at least two probability mean values per group. This makes it possible for the second processor P2 to perform a time-discrete collision check on the trajectory T.

In the abovementioned exemplary embodiments, which bring about an information reduction by means of probability mean values, these probability mean values WM1, WM2, WM3 of the at least one group G of cells are used to form the second environmental model 3.

When the probability of occupation of cells by dynamic objects is considered, the dynamic objects' own movement may be taken into account. In particular, the dynamic object's own motion may be taken as a basis for predicting whether cell Z is actually still or already occupied by a dynamic object at the time at which the vehicle 1 is in the region of this cell Z.

It goes without saying that also for an information reduction based on probabilities that the cells traversed by the body 1.1 of the vehicle 1 are free, a spatial limitation to the relevant environmental region can additionally take place.

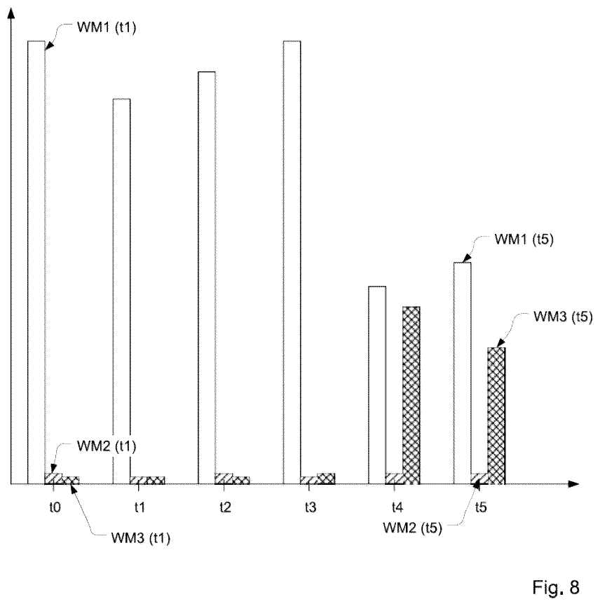

FIG. 8 shows by way of example and schematically a bar graph showing the probability mean values WM1, WM2, WM3 for the groups G of cells shown in FIG. 7.

Each time t0-t5 is assigned respective three probability mean values WM1, WM2, WM3, which indicate the mean value of the probability values W1, W2, W3 of the group of cells at the respective point in time. In this case, the first probability mean value WM1 indicates the probability that the group of cells is not occupied and is therefore freely traversable, the second probability mean value WM2 indicates that the group of cells is occupied by a static object, and the third probability mean value WM3 indicates that the group of cells is occupied by a dynamic object.

By assigning a plurality of probability mean values WM1, WM2, WM3 to a group of cells, information redundancy is obtained which can be used to check the plausibility of the information provided by the first processor unit P1. The probability mean values WM1, WM2, WM3 obtained at the times t0 to t3 indicate a group of cells that should be correctly considered as collision-free, since there is a very high probability mean value WM1 for “cells are free” and in each case very low probability mean values WM2, WM3 for “cells are occupied by a static object” and “cells are occupied by a dynamic object”.

In contrast, at the times t4 and t5, the mean probabilities WM1, WM2, WM3 indicate a lack of plausibility, since relatively high values are given both for the first probability mean value WM1 for “cells are free” and for the third probability mean value “cells are occupied by a dynamic object”. It can therefore be assumed here by the second processor P2 that it is not possible to release the trajectory T as being collision-free at least at times t4 and t5.

The invention has been described based on exemplary embodiments. It goes without saying that numerous changes and modifications are possible without departing from the scope of protection defined by the claims.

### LIST OF REFERENCE NUMERALS

1 vehicle
1.1 body
1.2 computing unit
1.3 sensor
2 first environmental model
2′ further environmental model
3 second environmental model
10, 10′ system
G group
P1 first processor
P1′ further processor
P2 second processor
W1 first probability value
W2 second probability value
W3 third probability value
WM1 first probability mean value
WM2 second probability mean value
WM3 third probability mean value
T trajectory
Z cells

1. A method for checking a planned trajectory of a vehicle for freedom from collision on the basis of an environmental model that has a plurality of cells, wherein the cells each correspond to an environmental region surrounding the vehicle and the cells are each assigned information which indicates whether the environmental region represented by the cell can be traversed without collision, wherein a first environmental model is processed by a first processor having a first safety integrity level which is lower than a safety level necessary to check the trajectory for freedom from collision, wherein the first processor determines at least one trajectory to be checked with regard to freedom from collision based on the first environmental model, wherein a second, information-reduced environmental model is generated from the first environmental model or a further environmental model which is different from the first environmental model by reducing the first environmental model or the further environmental model to information relevant to the collision checking of the trajectory, and wherein a second processor which has a second safety integrity level which corresponds at least to the safety integrity level which is necessary for checking the trajectory for freedom from collision, performs a collision check on the trajectory on the basis of the second, information-reduced environmental model.

2. The method according to claim 1, wherein the cells of the first environmental model and/or of the further environmental model are each assigned multiple probability values, wherein a first probability value indicates the probability that the respective cell is free.

3. The method according to claim 2, wherein a second probability value indicates the probability that the respective cell is occupied by a static object.

4. The method according to claim 2, wherein a third probability value indicates the probability that the respective cell is occupied by a dynamic object.

5. The method according to claim 2, wherein a plurality of probability mean values determined on the basis of the probability values of the cells of the first environmental model and/or of the further environmental model, wherein the probability mean values are each formed by averaging the probability values of a group of cells, which is at least temporarily occupied by the body of the vehicle when traversing the trajectory, and in that the probability mean values are used as information of the second, information-reduced environmental model by the second processor to check the trajectory for freedom from collision.

6. The method according to claim 5, wherein at least one first probability mean value is determined that indicates the probability that a group of cells, which is at least temporarily occupied by the body of the vehicle when traversing the trajectory, is free.

7. The method according to claim 5, wherein at least one second probability mean value is determined that indicates the probability that at least one static object is present in a group of cells, which is at least temporarily occupied by the body of the vehicle when traversing the trajectory.

8. The method according to claim 5, wherein at least one third probability mean value is determined that indicates the probability that at least one dynamic object is present in a group of cells which is at least temporarily occupied by the body of the vehicle when traversing the trajectory.

9. The method according to claim 5, wherein the probability mean values are formed by averaging the probability values of the cells of the first environmental model and/or of the further environmental model that are temporarily occupied by the body of the vehicle when traversing the entire trajectory to be checked.

10. The method according to claim 5, wherein the probability mean values relate to a group of cells of the first environmental model and/or of the further environmental model which are occupied by the body of the vehicle at a certain point in time when traversing the trajectory.

11. The method according to claim 10, wherein, to check the trajectory for freedom from collision, a plurality of groups of probability mean values are used, wherein each group of probability mean values respectively relates to a group of cells of the first environmental model and/or of the further environmental model which are occupied, at different times when traversing the trajectory, by the body of the vehicle.

12. The method according to claim 11, wherein a group of probability mean values
has a respective first probability mean value which indicates the probability that a group of cells of the first environmental model and/or of the further environmental model which is occupied by the body of the vehicle at a certain point in time when traversing the trajectory, is free;
has a respective second probability mean value, which indicates the probability that a group of cells of the first environmental model and/or of the further environmental model, which are occupied by the body of the vehicle at a certain point in time when traversing the trajectory, is occupied by at least one static object;
has a respective third probability mean value, which indicates the probability that a group of cells of the first environmental model and/or of the further environmental model which are occupied by the body of the vehicle at a certain point in time when traversing the trajectory, is occupied by at least one dynamic object.

13. The method according to claim 11, wherein, in the assessment of the trajectory for freedom from collision, the probability mean values of a group of probability mean values are compared with one another and a plausibility check is performed on the basis of the comparison of the probability mean values of a group.

14. The method according to claim 1, wherein the second, information-reduced environmental model is generated by reducing the first environmental model and/or the further environmental model to those cells which are temporarily occupied when the body of the vehicle is traversing the trajectory.

15. A system for checking a trajectory of a vehicle for freedom from collision, wherein the system has a first processor which provides a first environmental model of the vehicle which has a plurality of cells, wherein the cells each correspond to an environmental region surrounding the vehicle and the cells are each assigned information, which indicate whether the environmental region represented by the cell can be traversed without collision, wherein the first processor has a first safety integrity level that is lower than a safety level required to check the trajectory for freedom from collision, wherein the first processor is configured to determine on the basis of the first environmental model at least one trajectory to be checked with regard to freedom from collision, wherein the first processor or a further processor, which has a safety integrity level that is lower than a safety level necessary to check the trajectory for freedom from collision, is configured to generate a second, information-reduced environmental model from the first environmental model or a further environmental model by reducing the first environmental model or the further environmental model to information relevant for collision-checking of the trajectory, wherein a second processor is provided which has a second safety integrity level which corresponds at least to the safety integrity level required for checking the trajectory for freedom from collision, wherein the second processor is configured to perform a collision check on the trajectory on the basis of the second, information-reduced environmental model.

16. The method according to claim 3, wherein a third probability value indicates the probability that the respective cell is occupied by a dynamic object.

17. The method according to claim 6, wherein at least one second probability mean value is determined that indicates the probability that at least one static object is present in a group of cells, which is at least temporarily occupied by the body of the vehicle when traversing the trajectory.

18. The method according to claim 12, wherein, in the assessment of the trajectory for freedom from collision, the probability mean values of a group of probability mean values are compared with one another and a plausibility check is performed on the basis of the comparison of the probability mean values of a group.
